(19) United States
(12) Patent Application Publication
(10) Pub. No.: US 2018/0109816 A1
(43) Pub. Date: Apr. 19, 2018

(54) ACCOMPANYING MESSAGE DATA INCLUSION IN COMPRESSED VIDEO BITSREAMS SYSTEMS AND METHODS

(71) Applicant: REALNETWORKS, INC., Seattle, WA (US)

(72) Inventors: Chia-Yang TSAI, Seattle, WA (US); Gang WU, Seattle, WA (US); Kai WANG, Seattle, WA (US); Ihwan LIMASI, Seattle, WA (US)

(21) Appl. No.: 15/562,837

(22) PCT Filed: Mar. 31, 2015
(86) PCT No.: PCT/CN2015/075598

§ 371 Date: Sep. 28, 2017

(51) Int. Cl. H04N 21/236; H04N 21/434; H04N 19/70; H04N 19/46

(52) U.S. Cl. CPC H04N 21/236; H04N 19/46; H04N 19/70; H04N 21/434

(57) ABSTRACT

Methods and systems for inserting and extracting message data into and out of an encoded bitstream representative of an unencoded video frame are described herein. The unencoded video frame and at least one accompanying message for inclusion in the encoded bitstream are obtained and the unencoded video frame is encoded, thereby generating a video data payload of the encoded bitstream. A message size corresponding to the accompanying message(s) is obtained and a frame header of the encoded bitstream is generated. The frame header may include a message-enabled flag, a message-count flag, at least one message-size flag corresponding to each of the accompanying messages, and message-data corresponding to the contents of the accompanying message(s). The message-count flag indicates a number of accompanying messages being included in the frame header, and each message-size flag indicates the size of a corresponding accompanying message.

### FIELD

This disclosure relates to encoding and decoding of video signals, and more particularly, to the insertion and extraction of accompanying message data into and from a compressed video bitstream.

### BACKGROUND

The advent of digital multimedia such as digital images, speech/audio, graphics, and video have significantly improved various applications as well as opened up brand new applications due to relative ease by which it has enabled reliable storage, communication, transmission, and, search and access of content. Overall, the applications of digital multimedia have been many, encompassing a wide spectrum including entertainment, information, medicine, and security, and have benefited the society in numerous ways. Multimedia as captured by sensors such as cameras and microphones is often analog, and the process of digitization in the form of Pulse Coded Modulation (PCM) renders it digital. However, just after digitization, the amount of resulting data can be quite significant as is necessary to re-create the analog representation needed by speakers and/or TV display. Thus, efficient communication, storage, and/or transmission of the large volume of digital multimedia content requires its compression from raw PCM form to a compressed representation. Thus, many techniques for compression of multimedia have been invented. Over the years, video compression techniques have grown very sophisticated to the point that they can often achieve high compression factors between 10 and 100 while retaining high psycho-visual quality, often similar to uncompressed digital video.

Tremendous progress has been made to date in the art and science of video compression (as exhibited by the plethora of standards bodies driven video coding standards such as MPEG-1, MPEG-2, H.263, MPEG-4 part2, MPEG-4 AVC/H.264, MPEG-4 SVC and MVC, as well as industry driven proprietary standards such as Windows Media Video, RealVideo, On2 VP, and the like). However, the ever increasing appetite of consumers for even higher quality, higher definition, and now 3D (stereo) video, available for access whenever, wherever, has necessitated delivery via various means such as DVD/BD, over the air broadcast, cable/satellite, wired and mobile networks, to a range of client devices such as PCs/laptops, TVs, set top boxes, gaming consoles, portable media players/devices, smartphones, and wearable computing devices, fueling the desire for even higher levels of video compression. In the standards-body-driven standards, this is evidenced by the recently started effort by ISO MPEG in High Efficiency Video coding which is expected to combine new technology contributions and technology from a number of years of exploratory work on H.265 video compression by ITU-T standards committee.

All aforementioned standards employ a general interframe predictive coding framework that involves reducing temporal redundancy by compensating for motion between frames of video by first dividing a frame into sub-units, i.e. coding blocks, prediction blocks, and transform blocks. Motion vectors are assigned to each prediction block of a frame to be coded, with respect to a past decoded frame (which may be a past or future frame in display order); these motion vectors are then transmitted to a decoder and used to generate a motion compensated prediction frame that is differenced with a past decoded frame and coded block by block, often by transform coding. In past standards, these blocks were generally sixteen by sixteen pixels.

However, frame sizes have grown considerably larger and many mobile devices have the capability to display higher than “high definition” (or “HD”) frame sizes such as 20489×1530 pixels. Thus larger sized blocks are needed to efficiently encode the motion vectors for these frame size. However, it also may be desirable to be able to perform prediction and transformation on a relatively small scale, e.g. 4×4 pixels.

In the state-of-the-art video compression techniques, motion compensation is the essential part in the codec design. The basic concept is to remove the temporal dependencies between neighboring pictures by using block matching method. If the coding block can find another similar block in the reference picture, only the differences between these two coding blocks, called “residues” or “residue signals,” are coded. Besides, the motion vector (MV) which indicates the spatial distance between this two matching blocks is also coded. Therefore, only residues and MV are coded instead of the entire samples in the coding block. By removing this kind of temporal redundancy, the video samples can be compressed.

To further compress the video data, after inter or intra frame prediction techniques have been applied, the coefficients of the residual signal are often transformed from the spatial domain to the frequency domain (e.g. using a discrete cosine transform (“DCT”) or discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transformation, the coefficients are quantized and entropy encoded, along with any motion vectors and related syntax information. For each frame of unencoded video data, the corresponding encoded coefficients and motion vectors make up a video data payload and the related syntax information makes up a frame header associated with the video data payload.

On the decoder side, inversed quantization and inversed transforms are applied to the coefficients to recover the spatial residual signal. A reverse prediction process may then be performed in order to generate a recreated version of the original unencoded video sequence. These are typical prediction/transform/quantization processes common to most if not all video compression standards.

In conventional video encoding/decoding systems, all the elements at the freame header level of the bit-stream are designed for transmitting coding-related syntax information to a downstream decoder. However, an operator of the encoder may desire to provide downstream decoding systems with additional information, such as information related to the copyright of the material being transmitted, title, author name, digital rights management (“DRM”), etc.

### BRIEF DESCRIPTION OF THE DRAWINGS

FIG. 1 illustrates an exemplary video encoding/decoding system according to at least one embodiment.

FIG. 2 illustrates several components of an exemplary encoding device, in accordance with at least one embodiment.

FIG. 3 illustrates several components of an exemplary decoding device, in accordance with at least one embodiment.

FIG. 4 illustrates a functional block diagram of an exemplary software implemented video encoder in accordance with at least one embodiment.

FIG. 5 illustrates a block diagram of an exemplary software implemented video decoder in accordance with at least one embodiment.

FIG. 6 illustrates a flow chart of a message insertion routine in accordance with at least one embodiment.

FIG. 7 illustrates a flow chart of a message extraction routine in accordance with at least one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Various embodiments are described in the context of a typical “hybrid” video coding approach, in that it uses inter-/intra-picture prediction and transform coding. An encoder first splits a picture (or frame) into block shaped regions called coding blocks for the first picture in the video sequence, and encodes the picture using intra-picture prediction. Intra-picture prediction is when the predicted values of the coding blocks in the picture are based only on the information in that picture. For subsequent pictures, inter-picture prediction may be used, in which prediction information is generated from other pictures. Periodically, subsequent pictures may be encoded using only intra-coding prediction, for example to allow decoding of the encoded video to begin at points other than the first picture of the video sequence. After the prediction methods are finished, the data representing the picture may be stored in a decoded picture buffer for use in the prediction of other pictures.

Those having ordinary skill in the art will recognize that in various embodiments, the message insertion/extraction techniques described below can be integrated into many otherwise conventional video encoding/decoding processes, for example encoding/decoding processes that use traditional picture structures composed of I-, P-, B-picture coding. In other embodiments, the techniques described below can be integrated in video coding that uses other structures in addition to I-, and P-pictures, such as hierarchical B-pictures, unidirectional B-pictures, and/or B-picture alternatives.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

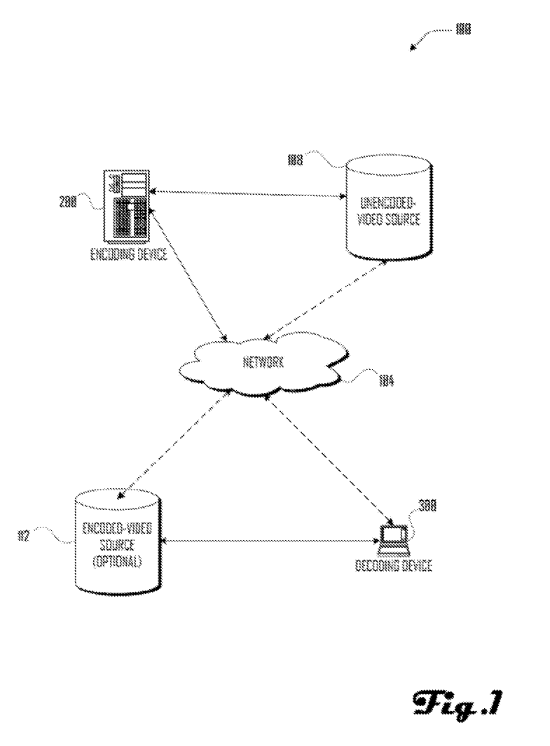

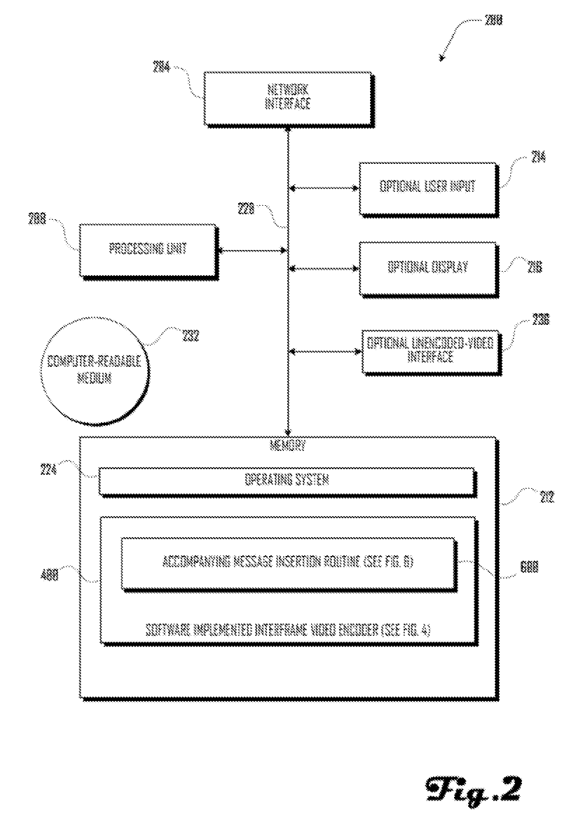

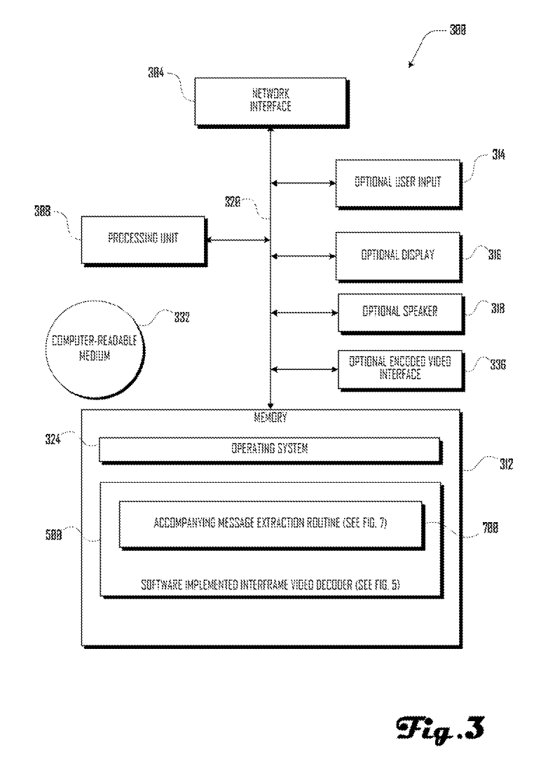

FIG. 1 illustrates an exemplary video encoding/decoding system 100 in accordance with at least one embodiment. Encoding device 200 (illustrated in FIG. 2 and described below) and decoding device 300 (illustrated in FIG. 3 and described below) are in data communication with a network 104. Decoding device 200 may be in data communication with unencoded video source 108, either through a direct data connection such as a storage area network (“SAN”), a high speed serial bus, and/or via other suitable communication technology, or via network 104 (as indicated by dashed lines in FIG. 1). Similarly, encoding device 300 may be in data communication with an optional encoded video source 112, either through a direct data connection, such as a storage area network (“SAN”), a high speed serial bus, and/or via other suitable communication technology, or via network 104 (as indicated by dashed lines in FIG. 1). In some embodiments, encoding device 200, decoding device 300, encoded-video source 112, and/or unencoded-video source 108 may comprise one or more replicated and/or distributed physical or logical devices. In many embodiments, there may be more encoding devices 200, decoding devices 300, unencoded-video sources 108, and/or encoded-video sources 112 than are illustrated.

In various embodiments, encoding device 200, may be a networked computing device generally capable of accepting requests over network 104, e.g. from decoding device 300, and providing responses accordingly. In various embodiments, decoding device 300 may be a networked computing device having a form factor such as a mobile-phone; watch, glass, or other wearable computing device; a dedicated media player; a computing tablet; a motor vehicle head unit; an audio-video on demand (AVOD) system; a dedicated media console; a gaming device, a “set-top box,” a digital video recorder, a television, or a general purpose computer. In various embodiments, network 104 may include the Internet, one or more local area networks (“LANs”), one or more wide area networks (“WANs”), cellular data networks, and/or other data networks. Network 104 may, at various points, be a wired and/or wireless network.

Referring to FIG. 2, several components of an exemplary encoding device 200 are illustrated. In some embodiments, an encoding device may include many more components than those shown in FIG. 2. However, it is not necessary that all of these generally conventional components be shown in order to disclose an illustrative embodiment. As shown in FIG. 2, exemplary encoding device 200 includes a network interface 204 for connecting to a network, such as network 104. Exemplary encoding device 200 also includes a processing unit 208, a memory 212, an optional user input 214 (e.g. an alphanumeric keyboard, keypad, a mouse or other pointing device, a touchscreen, and/or a microphone), and an optional display 216, all interconnected along with the network interface 204 via a bus 220. The memory 212 generally comprises a RAM, a ROM, and a permanent mass storage device, such as a disk drive, flash memory, or the like.

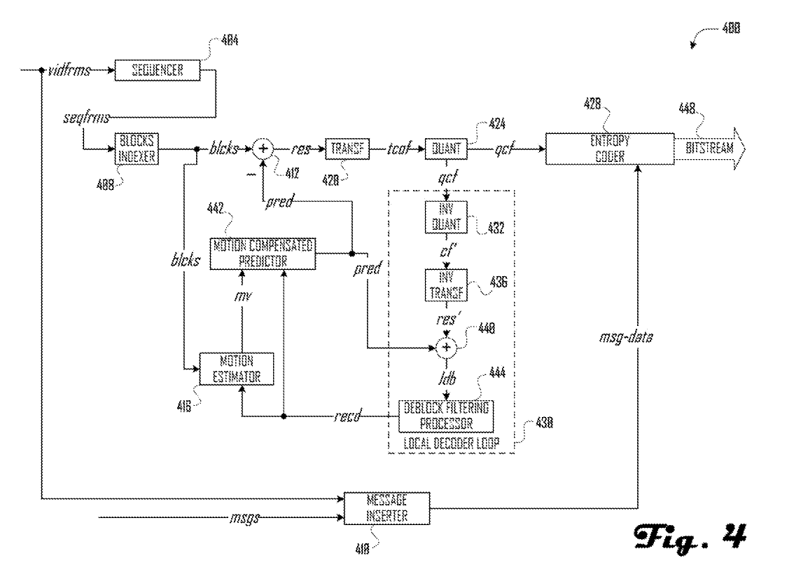

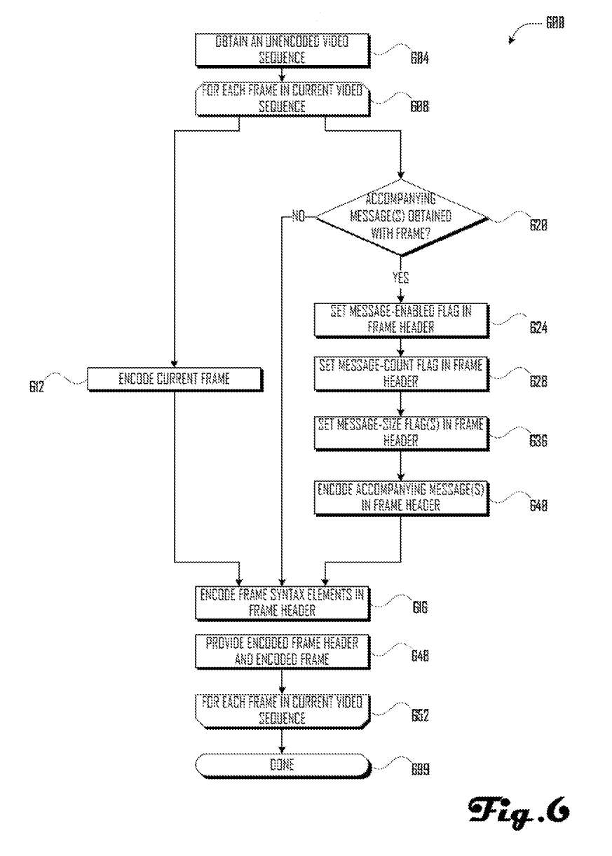

The memory 212 of exemplary encoding device 200 stores an operating system 224 as well as program code for a number of software services, such as software implemented interframe video encoder 400 (described below in reference to FIG. 4) with instructions for performing an accompanying-message insertion routine 600 (described below in reference to FIG. 6). Memory 212 may also store video data files (not shown) which may represent unencoded copies of audio/visual media works, such as, by way of non-limiting examples, movies and/or television episodes. These and other software components may be loaded into memory 212 of encoding device 200 using a drive mechanism (not shown) associated with a non-transitory computer-readable medium 232, such as a floppy disc, tape, DVD/CD-ROM drive, memory card, or the like. Although an exemplary encoding device 200 has been described, an encoding device may be any of a great number of networked computing devices capable of communicating with network 120 and executing instructions for implementing video encoding software, such as exemplary software implemented video encoder 400, and accompanying-message insertion routine 600.

In operation, the operating system 224 manages the hardware and other software resources of the encoding device 200 and provides common services for software applications, such as software implemented interframe video encoder 400. For hardware functions such as network communications via network interface 204, receiving data via input 214, outputting data via display 216, and allocation of memory 212 for various software applications, such as software implemented interframe video encoder 400, operating system 224 acts as an intermediary between software executing on the encoding device and the hardware.

In some embodiments, encoding device 200 may further comprise a specialized unencoded video interface 236 for communicating with unencoded-video source 108, such as a high speed serial bus, or the like. In some embodiments, encoding device 200 may communicate with unencoded-video source 108 via network interface 204. In other embodiments, unencoded-video source 108 may reside in memory 212 or computer readable medium 232.

Although an exemplary encoding device 200 has been described that generally conforms to conventional general purpose computing devices, an encoding device 200 may be any of a great number of devices capable of encoding video, for example, a video recording device, a video co-processor and/or accelerator, a personal computer, a game console, a set-top box, a handheld or wearable computing device, a smart phone, or any other suitable device.

Encoding device 200 may, by way of non-limiting example, be operated in furtherance of an on-demand media service (not shown). In at least one non-limiting, exemplary embodiment, the on-demand media service may be operating encoding device 200 in furtherance of an online on-demand media store providing digital copies of media works, such as video content, to users on a per-work and/or subscription basis. The on-demand media service may obtain digital copies of such media works from unencoded video source 108.

Referring to FIG. 3, several components of an exemplary decoding device 300 are illustrated. In some embodiments, a decoding device may include many more components than those shown in FIG. 3. However, it is not necessary that all of these generally conventional components be shown in order to disclose an illustrative embodiment. As shown in FIG. 3, exemplary decoding device 300 includes a network interface 304 for connecting to a network, such as network 104. Exemplary decoding device 300 also includes a processing unit 308, a memory 312, an optional user input 314 (e.g. an alphanumeric keyboard, keypad, a mouse or other pointing device, a touchscreen, and/or a microphone), an optional display 316, and an optional speaker 318, all interconnected along with the network interface 304 via a bus 320. The memory 312 generally comprises a RAM, a ROM, and a permanent mass storage device, such as a disk drive, flash memory, or the like.

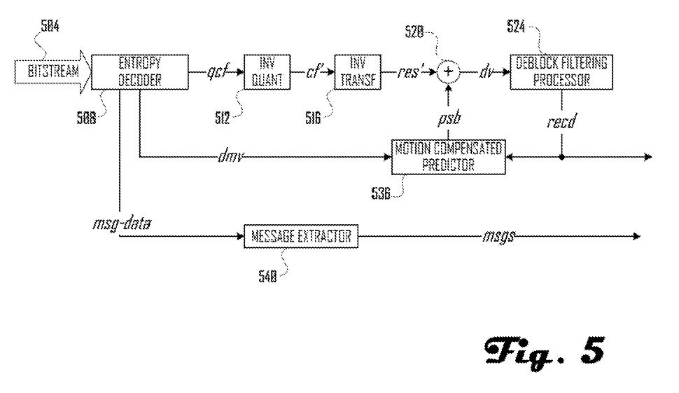

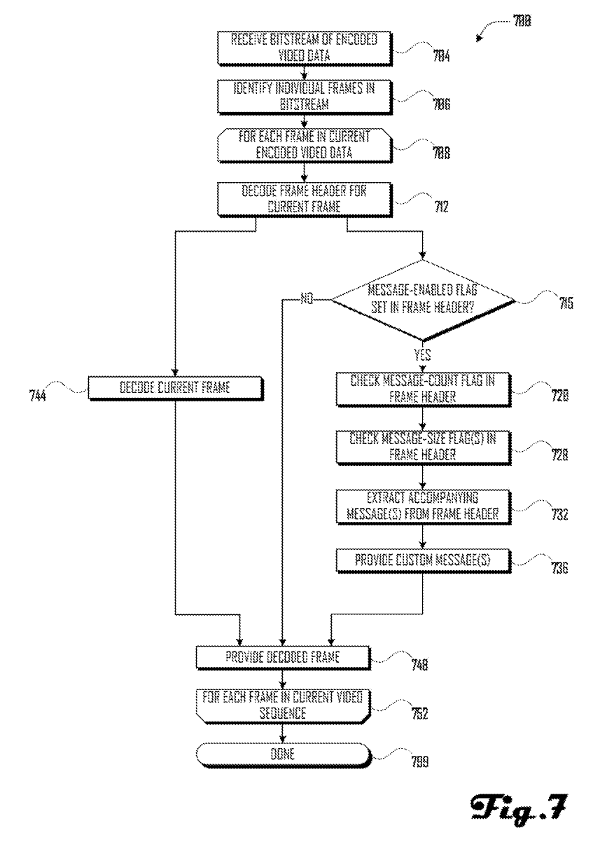

The memory 312 of exemplary decoding device 300 may store an operating system 324 as well as program code for a number of software services, such as software implemented video decoder 500 (described below in reference to FIG. 5) with instructions for performing an accompanying-message extraction routine 700 (described below in reference to FIG. 7). Memory 312 may also store video data files (not shown) which may represent encoded copies of audio/visual media works, such as, by way of non-limiting examples, movies and/or television episodes. These and other software components may be loaded into memory 312 of decoding device 300 using a drive mechanism (not shown) associated with a non-transitory computer-readable medium 332, such as a floppy disc, tape, DVD/CD-ROM drive, memory card, or the like. Although an exemplary decoding device 300 has been described, a decoding device may be any of a great number of networked computing devices capable of communicating with a network, such as network 120, and executing instructions for implementing video decoding software, such as exemplary software implemented video decoder 500, and accompanying-message extraction routine 700.

In operation, the operating system 324 manages the hardware and other software resources of the decoding device 300 and provides common services for software applications, such as software implemented video decoder 500. For hardware functions such as network communications via network interface 304, receiving data via input 314, outputting data via display 316 and/or optional speaker 318, and allocation of memory 312, operating system 324 acts as an intermediary between software executing on the encoding device and the hardware.

In some embodiments, decoding device 300 may further comprise a optional encoded video interface 336, e.g. for communicating with encoded-video source 116, such as a high speed serial bus, or the like. In some embodiments, decoding device 300 may communicate with an encoded-video source, such as encoded video source 116, via network interface 304. In other embodiments, encoded-video source 116 may reside in memory 312 or computer readable medium 332.

Although an exemplary decoding device 300 has been described that generally conforms to conventional general purpose computing devices, an decoding device 300 may be any of a great number of devices capable of decoding video, for example, a video recording device, a video co-processor and/or accelerator, a personal computer, a game console, a set-top box, a handheld or wearable computing device, a smart phone, or any other suitable device. Decoding device 300 may, by way of non-limiting example, be operated in furtherance of the on-demand media service. In at least one non-limiting, exemplary embodiment, the on-demand media service may provide digital copies of media works, such as video content, to a user operating decoding device 300 on a per-work and/or subscription basis. The decoding device may obtain digital copies of such media works from unencoded video source 108 via, for example, encoding device 200 via network 104.

FIG. 4 shows a general functional block diagram of software implemented interframe video encoder 400 (hereafter “encoder 400”) employing motion compensated prediction techniques and accompanying message insertion capabilities in accordance with at least one embodiment. One or more unencoded video frames (vidfrms) of a video sequence may be provided to sequencer 404 in display order.

Sequencer 404 may assign a predictive-coding picture-type (e.g. I, P, or B) to each unencoded video frame and reorder the sequence of frames into a coding order. The sequenced unencoded video frames (seqfrms) may then be input in coding order to blocks indexer 408 and message inserter 410.

For each of the sequenced unencoded video frames (seqfrms), blocks indexer 408 may determine a largest coding block (“LCB”) size for the current frame (e.g. sixty-four by sixty-four pixels) and divides the unencoded frame into an array of coding blocks (cblks). Individual coding blocks within a given frame may vary in size, e.g. from eight by eight pixels up to the LCB size for the current frame.

Each coding block may then be input one at a time to differencer 412 and differenced with corresponding prediction signal blocks (pred) generated from previously encoded coding blocks. Coding blocks (cblks) may also be provided to motion estimator 416 (discussed below). After differencing at differencer 412, a resulting residual signal (res) may be forward-transformed to a frequency-domain representation by transformer 420, resulting in a block of transform coefficients (tcof). The block of transform coefficients (tcof) may then be sent to the quantizer 424 resulting in a block of quantized coefficients (qcf) that may then be sent both to an entropy coder 428 and to a local decoding loop 430.

At the beginning of local decoding loop 430, inverse quantizer 432 may de-quantize the block of transform coefficients (tcof) and pass them to inverse transformer 436 to generate a de-quantized residual block (res′). At adder 440, a prediction block (pred) from motion compensated predictor 442 may be added to the de-quantized residual block (res′) to generate a locally decoded block (rec). Locally decoded block (rec) may then be sent to a frame assembler and deblock filter processor 444, which reduces blockiness and assembles a recovered frame (recd), which may be used as the reference frame for motion estimator 416 and motion compensated predictor 442.

Entropy coder 428 encodes the quantized transform coefficients (qcf), differential motion vectors (dmv), and other data, generating an encoded video bitstream 448. For each frame of the unencoded video sequence, encoded video bitstream 448 may include encoded picture data (e.g. the encoded quantized transform coefficients (qcf) and differential motion vectors (dmv)) and an encoded frame header (e.g. syntax information such as the LCB size for the current frame).

In accordance with at least one embodiment, and as is described in more detail below with reference to FIG. 6, one or more messages (msgs) may be obtained in parallel with the video sequence for inclusion with encoded video bitstream 448. Message data (msgs) may be received by message inserter 410 and formed into accompanying message data packets (msg-data) for insertion into frame headers of bitstream 448. The one or more messages may be associated with specific frames (vidfrms) of the video sequence and therefore may be incorporated into the frame header or headers of those frames. Messages obtained by message inserter 410 are associated with one or more frames of the video sequence and provided to entropy encoder 428 for insertion into encoded video bitstream.

FIG. 5 shows a general functional block diagram of corresponding software implemented interframe video decoder 500 (hereafter “decoder 500”) employing motion compensated prediction techniques and accompanying message extraction capabilities in accordance with at least one embodiment and being suitable for use with a decoding device, such as decoding device 300. Decoder 500 may work similarly to the local decoding loop 455 at encoder 400.

Specifically, an encoded video bitstream 504 to be decoded may be provided to an entropy decoder 508, which may decode blocks of quantized coefficients (qcf), differential motion vectors (dmv), accompanying message data packets (msg-data) and other data.

The quantized coefficient blocks (qcf) may then be inverse quantized by an inverse quantizer 512, resulting in de-quantized coefficients (tcof). De-quantized coefficients (tcof) may then be inverse transformed out of the frequency-domain by an inverse transformer 516, resulting in decoded residual blocks (res′).

An adder 520 may add motion compensated prediction blocks (pred) obtained by using corresponding motion vectors (my). The resulting decoded video (dv) may be deblock-filtered in a frame assembler and deblock filtering processor 524.

Blocks (recd) at the output of frame assembler and deblock filtering processor 528 form a reconstructed frame of the video sequence, which may be output from the decoder 500 and also may be used as the reference frame for a motion-compensated predictor 532 for decoding subsequent coding blocks. Motion compensated predictor 536 works in a similar manner as the motion compensated predictor 442 of encoder 400.

In parallel with the decoding process described above, and is described in more detail below in reference to FIG. 7, any accompanying message data (msg-data) received with encoded video bitstream 504 is provided to message extractor 540. Message extractor 540 processes the accompanying message data (msg-data) to recreate one or more accompanying messages (msgs) which were included in the encoded video bitstream, such as in the manner described above in reference to FIG. 4 and below in reference to FIG. 6. Once extracted from the encoded video bitstream, the accompanying message(s) may be provided to other components of the decoding device 300, such as operating system 324. The accompanying message(s) may include instructions to the decoding device regarding how other portions of the accompanying message(s) are to be processed, such as causing decoding device 300 to display information about the video sequence being decoded, or to cause a particular digital rights management system to be employed in regard to the video sequence being decoded, such as by granting or denying permission for the decoding device 300 to store a copy of the video sequence in a non-transitory storage medium.

FIG. 6 illustrates an embodiment of a video coding routine having accompanying message insertion capabilities 600 (hereafter “accompanying-message insertion routine 600”) suitable for use with a video encoder, such as encoder 400. As will be recognized by those having ordinary skill in the art, not all events in the video encoding process are illustrated in FIG. 6. Rather, for clarity, only those steps reasonably relevant to describing the accompanying message insertion aspects of accompanying-message insertion routine 600 are shown. Those having ordinary skill in the art will also recognize the present embodiment is merely one exemplary embodiment and that variations on the present embodiment may be made without departing from the scope of the broader inventive concept as it is defined by the claims below.

At execution block 604, accompanying-message insertion routine 600 obtains an unencoded video sequence. Beginning at starting loop block 608, each frame of the unencoded video sequence is processed in turn. At execution block 612, the current frame is encoded.

In parallel with execution block 612, at decision block 620, if no accompanying messages are obtained with the current frame, then accompanying-message insertion routine 600 proceeds to execution block 644, described below.

Returning to decision block 620, if one or more accompanying messages are obtained with the current frame, then accompanying-message insertion routine 600 sets a custom-message-enabled flag in the frame header at execution block 624. For example, in at least one embodiment the custom-message-enabled flag may be a one bit in length having two possible values, wherein one possible value indicates the presence of accompanying messages in the current frame's frame header and the second possible value indicates that no accompanying messages are present in the current frame's frame header.

At execution block 628, accompanying-message insertion routine 600 sets a message-count flag in the frame header. For example, in at least one embodiment, the message-count flag could be a two bits in length having four possible values, wherein each possible value indicates a count of accompanying messages being included in the frame header of the current frame (e.g. “00” may indicate one accompanying message, “01” may indicate two accompanying messages, etc.).

At execution block 636, accompanying-message insertion routine 600 sets a custom-message-length flag in the frame header for each accompanying message being included in the frame header of the current frame. For example, the custom-message-length flag may be a two bit long flag having four possible values, wherein each possible value indicates a length of current accompanying message (e.g. “00” may indicate a message length of two bytes, “01” may a indicate message length of four bytes, “10” may indicate a message length of sixteen bytes, and “11” may indicate a message length of thirty-two bytes).

At execution block 640, accompanying-message insertion routine 600 may then encode the accompanying message(s) in the frame header of the current frame.

At execution block 644, accompanying-message insertion routine 600 may encode frame syntax elements in the frame header for the current frame.

At execution block 648, accompanying-message insertion routine 600 may provide the encoded frame header and the encoded frame for inclusion in an encoded bitstream.

At ending loop block 652, accompanying-message insertion routine 600 loops back to starting loop block 608 to process any remaining frames in the unencoded video sequence as has just been described.

Accompanying-message insertion routine 600 ends at termination block 699.

FIG. 7 illustrates a video decoding routine having accompanying message extraction capabilities 700 (hereafter “accompanying-message extraction routine 700”) suitable for use with at least one embodiment, such as decoder 500. As will be recognized by those having ordinary skill in the art, not all events in the video decoding process are illustrated in FIG. 7. Rather, for clarity, only those steps reasonably relevant to describing the accompanying message extraction aspects of routine 700 are shown and described. Those having ordinary skill in the art will also recognize the present embodiment is merely one exemplary embodiment and that variations on the present embodiment may be made without departing from the scope of the broader inventive concept as it is defined by the claims below.

At execution block 704, accompanying-message extraction routine 700 obtains a bitstream of encoded video data.

At execution block 706, accompanying-message extraction routine 700 identifies portions of the bitstream that represent individual frames of an unencoded video sequence, e.g. by interpreting portions of the bitstream that correspond to frame headers.

Beginning in starting loop block 708, each identified frame in the encoded video data is processed in turn. At execution block 712, the frame header for the current frame is decoded. At execution block 714, the video data payload for the current frame is decoded.

In parallel with execution block 714, at decision block 715, if the message-enabled flag in the frame header for the current frame is not set, then accompanying-message extraction routine may proceed to execution block 748, described below.

Returning to decision block 715, if the message-enabled flag in the frame header for the current frame is set, then at execution block 720, accompanying-message extraction routine 700 reads the message-count flag in the frame header for the current frame to determine how many accompanying messages are included in the frame header. As described above, the message-count flag may be two bits in length and have four possible values, with the received value corresponding to the number of accompanying messages present in the frame header of the current frame.

At execution block 728, accompanying-message extraction routine 700 reads the message size flag(s) for the accompanying message(s) included in the frame header for the current frame. As described above, the message-size flag may be two bits in length and have four possible values, wherein each possible value indicates a length of current accompanying message (e.g. “00” may indicate a message length of two bytes, “01” may a indicate message length of four bytes, “10” may indicate a message length of sixteen bytes, and “11” may indicate a message length of thirty-two bytes).

At execution block 732, accompanying-message extraction routine 700 extracts the accompanying message(s) from the frame header of the current frame, e.g. by copying the appropriate number of bits from the frame header indicated by the message-size flag associated with the accompanying message.

At execution block 736, accompanying-message extraction routine 700 may then provide the accompanying message(s), e.g. to the operating system of a decoding device, such as decoding device 300.

At execution block 748, accompanying-message extraction routine 700 may then provide decoded frame, e.g. to a display of a decoding device, such as decoding device 300.

At ending loop block 752, accompanying-message extraction routine 700 returns to starting loop block 708 to process any remaining frames in the unencoded video sequence as has just been described.

Accompanying-message extraction routine 700 ends at termination block 799.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

What is claimed is:

1. A video-encoder-device-implemented method of inserting message data into an encoded bitstream representative of a sequence of unencoded video frames, the method comprising:
obtaining an unencoded video frame of the sequence of unencoded video frames;
encoding said unencoded video frame to generate a video data payload;
obtaining an accompanying message;
determining a message size of said accompanying message;
encoding a frame header for said video data payload; and
providing said frame header and said video data payload as part of the encoded bitstream; and
wherein said frame header includes a message-enabled flag, said message-enabled flag indicating said accompanying message is included in said frame header; a message-count flag, said message-count flag indicating a count of accompanying messages, including said accompanying message, being included in said frame header; a message-size flag, said message-size flag indicating said message size; and said accompanying message.

2. The video-encoder-device-implemented method of claim 1, wherein said message-size flag indicates one of four possible message sizes of said accompanying message.

3. The video-encoder-device-implemented method of claim 2, wherein said four possible message sizes are two bytes, four bytes, sixteen bytes, and thirty-two bytes.

4. The video-encoder-device-implemented method of claim 1, wherein said message-count flag indicates up to four accompanying messages being included in said frame header.

5. The video-encoder-device-implemented method of claim 1, wherein said accompanying message includes data representative of information relating to said unencoded video frame.

6. The video-encoder-device-implemented method of claim 5, wherein the sequence of unencoded video frames makes up an audio-visual work and said accompanying message includes data identifying an author of said audio-visual work.

7. The video-encoder-device-implemented method of claim 5 wherein the sequence of unencoded video frames makes up an audio-visual work and said accompanying message includes data identifying a title of said audio-visual work.

8. The video-encoder-device-implemented method of claim 5 wherein the sequence of unencoded video frames makes up an audio-visual work and said accompanying message includes data relating to a copyright of said audio-visual work.

9. The video-encoder-device-implemented method of claim 5, wherein the sequence of unencoded video frames makes up an audio-visual work and said accompanying message includes data relating to permission to present a copy of said audio-visual work reconstructed from the encoded bitstream.

10. The video-encoder-device-implemented method of claim 5, wherein the sequence of unencoded video frames makes up an audio-visual work and said accompanying message includes data relating to permission to store a copy of the audio-visual work in a non-transitory storage medium.

11. A video-decoder-device-implemented method of extracting message data from an encoded bitstream representative of a sequence of video frames, the method comprising:
obtaining a video data payload from the encoded bitstream;
decoding said video data payload to generate a representation of a video frame of the sequence of video frames;
obtaining a frame header from the encoded bitstream;
decoding said frame header; and
providing said representation of the video frame and an accompanying message; and
wherein said frame header includes a message-enabled flag, said message-enabled flag indicating a presence of said accompanying message in said frame header; a message-count flag, said message-count flag indicating a count of accompanying messages, including said accompanying message, included in said frame header; a message-size flag, said message-size flag being associated with said accompanying message and indicating a message size of said accompanying message; and said accompanying message.

12. The video-decoder-device-implemented method of claim 11, wherein said message-size flag indicates one of four possible message sizes of said first accompanying message.

13. The video-decoder-device-implemented method of claim 12, wherein said four possible message sizes are two bytes, four bytes, sixteen bytes, and thirty-two bytes.

14. The video-decoder-device-implemented method of claim 11, wherein said message-count flag indicates up to four accompanying messages included in said frame header.

15. The video-decoder-device-implemented method of claim 11, wherein said first accompanying message includes data representative of information relating to said video frame.

16. The video-decoder-device-implemented method of claim 15, wherein the sequence of video frames makes up an audio-visual work and said accompanying message includes data identifying an author of said audio-visual work.

17. The video-decoder-device-implemented method of claim 15, wherein the sequence of video frames makes up an audio-visual work and said accompanying message includes data identifying a title of said audio-visual work.

18. The video-decoder-device-implemented method of claim 15, wherein the sequence of video frames makes up an audio-visual work and said accompanying message includes data relating to a copyright of said audio-visual work.

19. The video-decoder-device-implemented method of claim 15, wherein the sequence of video frames makes up an audio-visual work and said accompanying message includes data relating to permission to present a copy of said audio-visual work reconstructed from the encoded bitstream.

20. The video-decoder-device-implemented method of claim 15, wherein the sequence of video frames makes up an audio-visual work and said accompanying message includes data relating to permission to store a copy of the audio-visual work in a non-transitory storage medium.
